(19) United States
(12) Patent Application Publication
(10) Pub. No.: US 2026/0203368 A1
(43) Pub. Date: Jul. 16, 2026

(54) METHODS FOR LOOKUP TABLE-BASED MIXED-PRECISION MATRIX MULTIPLICATION

(71) Applicant: Microsoft Technology Licensing, LLC, Redmond, WA (US)

(72) Inventors: Mao YANG, Beijing (CN); Shijie CAO, Beijing (CN); Ting CAO, Beijing (CN); Lingxiao MA, Beijing (CN)

(73) Assignee: Microsoft Technology Licensing, LLC, Redmond, WA (US)

(21) Appl. No.: 19/025,510

(22) Filed: Jan. 16, 2025

(51) Int. Cl. G06F 17/16; G06F 1/03

(52) U.S. Cl. CPC G06F 17/16; G06F 1/03

(57) ABSTRACT

A method is presented for mixed-precision matrix multiplication. The method comprises decomposing an n-bit weight matrix into a series of n one-bit matrices. An m-bit activation matrix is received, where m>n. A lookup table of partial matrix multiplication results is generated based on permutations of groups of the m-bit activation matrix and the n one-bit matrices. An input weight matrix is received, the input weight matrix having a depth of g bits. For each bit of the input weight matrix, partial matrix multiplication results are retrieved from the lookup table using g-bit groups of the input weight matrix as indices. The retrieved partial matrix multiplication results are aggregated into a final mixed-precision matrix multiplication result.

### BACKGROUND

More and more large language models (LLMs) are deploying on mobile and edge devices, such as smartphones, desktops, and robotics, to enhance on-device intelligence by providing unprecedented intelligence services, real-time task responses, and user data protection. Some devices collaboratively run an on-device LLM with an on-cloud LLM. Deploying LLMs on edge devices brings several compelling benefits. On-device processing drastically reduces response latencies, which matters for time-sensitive applications such as autonomous vehicles and interactive robotics. Furthermore, local data processing enhances user privacy by keeping sensitive information confined to the device, thereby reducing the risk of data leakage. Another significant advantage is the operational reliability that comes with network independence, allowing for consistent functionality regardless of network availability or stability.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method is presented for mixed-precision matrix multiplication. The method comprises decomposing an n-bit weight matrix into a series of n one-bit matrices. An m-bit activation matrix is received, where m>n. A lookup table of partial matrix multiplication results is generated based on permutations of groups of the m-bit activation matrix and the n one-bit matrices. An input weight matrix is received, the input weight matrix having a depth of g bits. For each bit of the input weight matrix, partial matrix multiplication results are retrieved from the lookup table using g-bit groups of the input weight matrix as indices. The retrieved partial matrix multiplication results are aggregated into a final mixed-precision matrix multiplication result.

### BRIEF DESCRIPTION OF THE DRAWINGS

FIG. 1 shows a schematic for bit-wise mixed precision matrix multiplication with look-up table implementation.

FIG. 2 shows a flow-diagram for an example method for mixed-precision matrix multiplication.

FIG. 3 shows a schematic for implementing the method of FIG. 2 on a computing device.

FIG. 4 illustrates a naïve example of using LUT for FP16 activations multiplied by INT1 or INT2 weights.

FIG. 5 shows an example data flow for a look-up table based mixed precision matrix multiplication as materialized on a central processing unit.

FIG. 6 schematically shows a technique for weight interleaving.

FIG. 7 schematically shows techniques for look-up table quantization and mirror consolidation.

FIG. 8 schematically shows an example look-up table unit with a bit-serial circuit architecture.

FIG. 9 schematically shows an example look-up table array.

FIG. 10 schematically shows an example computing device.

### DETAILED DESCRIPTION

LLMs rely on a decoder-only transformer architecture to generate contextually cohesive output. Specifically, LLMs are generally built with sequential transformer layers, where each transformer layer contains a multi-head attention block followed by a feed forward block. In both multi-head attention block and feed forward block, the primary computations are general matrix multiplication (GEMM) operations or mixed-precision general matrix multiplication (mpGEMM) operations with weight quantization. Studies on scaling law suggest that LLMs will produce improved results when scaling up transformer layers. Consequently, there is a rapid growth in the scale of models, which in turn requires significant hardware resources.

One challenge in deploying LLMs on edge devices is thus the substantial memory requirement necessary to accommodate these models. LLMs often encompass billions of parameters. Further, edge devices often process data in a single-instance fashion, commonly with a batch size of one, to cater to a single user's real-time interactions. The inference process of the LLM can be divided into two stages: the prefill and decode. The prefill stage, with the self-attention mechanism applied across all input tokens, involves compute intensive matrix-matrix multiplications. However, once the key-value (KV) cache is generated, the decode stage becomes the bottleneck. In this phase, generating each subsequent token necessitates loading and processing the entire model, which translates to memory-intensive matrix-vector multiplications. Another challenge is power or energy efficiency, which particularly applies to battery-operated edge devices such as smartphones and robotics. These devices are designed for prolonged operation on finite energy reserves, making energy efficiency a design consideration.

Low-bit weight quantization is used for reducing the memory footprint of LLMs on devices with limited hardware resources. Weight quantization involves reducing the precision of the model's parameters, effectively allowing the model to occupy less memory and potentially speed up computation by leveraging lower-precision arithmetic. The values of model weights are known ahead of time and thus can be quantized offline. Weights can be quantized to 4-bit, 2-bit, and even 1-bit without impacting model accuracy significantly.

Fundamentally, the choice of bitwidth or precision in weight quantization represents a trade-off between computational efficiency and model accuracy. However, LLM inference quality is robust to precision loss. Conversely, activations are generated on-the-fly with a high variance, noticeably presented as dynamic outliers. These outliers can lead to significant accuracy degradation. In some cases, it is difficult to maintain model accuracy even with 8-bit activations. The computing operands thus have asymmetric precision and bit width, such as W4A16, W2A16, or W1A8. Low-bit LLMs thus necessitate mpGEMM of lower precision weights and higher precision activations during inference.

However, current commodity hardware still supports fixed bit-width and symmetric operands, and does not support mpGEMM natively. These architectures are traditionally optimized for standard operations where both operands share the same data type and precision level. In response to this limitation, existing systems implement an indirect approach by employing dequantization, which involves converting low-precision weights back to a higher precision to align with activation precision. This process enables the use of high-precision GEMM for low-bit LLM inference. This conversion raises multiple issues. As an example, the computing cost of the conversion offsets any gains from bit scaling down the weights, and may increase latency costs while performing inference. Further, the efficacy of such methods is contingent upon the assumption that dequantization does not become a bottleneck and can be overlapped with memory loading.

The diversity of bitwidths and precisions required by different deployment scenarios compounds this complexity. Depending on the task's difficulty and the specific requirements of the deployment environment, a variety of bit-widths may be selected to optimize performance. No single bit-width or precision setting can universally satisfy the diverse demands of all possible use cases. Consequently, this necessitates computational approaches capable of supporting a spectrum of low-bit widths, ensuring adaptability to the wide-ranging needs of edge computing tasks. Effectively deploying LLM on client devices will necessitate direct and efficient support for mpGEMM of low bit weights and high bit activations on devices. Further, data layouts and kernels would need to be designed on a case-by-case basis for each type of mixed precision.

One approach to the computation of quantized models is the adoption of Lookup Table (LUT)-based methods. For quantized Convolutional Neural Networks (CNNs), where both weights and activations are quantized to levels such as 4-bit, 2-bit, or 1-bit, all possible products of weights and activations may be precomputed, stored in a lookup table, and efficiently accessed at inference time to avoid costly multiply-accumulate operations. The LUT-based approach has been explored on graphics processing units (GPUs). These methods leverage the GPU's shared memory or cache to store and access the lookup tables. However, despite the theoretical reduction in computational complexity, the practical kernel performance is worse than dequantization-based kernels. The suboptimal kernel performance is attributable to the constraints of the GPU's fixed architecture, which offers either inadequate storage capacity for the lookup tables or insufficiently rapid table access.

The multiplication of two numbers can be transformed into multiplying one number by each bit of the other number, then shifting and adding the partial products. The mpGEMM between activation and weight matrices may thus be decomposed into a series (equal to the bit-width of the weights) of mpGEMM between activations and a one-bit matrix, then adding the partial results up. The disclosed methods can thus support any bit-width combination of activation and weight.

Since one bit can only represent two values (e.g., 1/−1), the bit patterns of a one-bit vector are groups of four-element vectors. The number of possible bit patterns (e.g., [1, 1, 1, −1] and [1, 1, −1, −1]) for each group is only 2⁴. Given an activation, its products can be first computed with all possible bit patterns and saved in tables. The mpGEMM of activation and the one-bit weight matrix can then be transformed to 1) table lookup indexed by each bit pattern in weight, and 2) addition to accumulate the looked-up results. No multiplication is necessary.

One difference between bit-wise LUT and traditional mpGEMM is the two operands for LUT method are tables and index matrices, rather than activations and weights. The data format and layout of the two operands thus inform the inference speed. Another challenge is that compared to the continuous data access for activation and weight, the access to tables is random. The table may thus reside in fast on-chip memory. However, the on-chip memory is limited, and the LUT method enlarges the on-chip memory usage compared to traditional mpGEMM. This is because the LUT needs to save the results of the activation vector multiplied with all possible bit patterns. This requires exponentially more storage than simply storing the activation itself.

To alleviate the random-access cost of LUT, changes in both the system and algorithm may be used to enable the LUT to reside in the fastest on-chip memory and parallel lookup. A LUT-centric data layout is provided herein, to ensure a LUT in on-chip memory, e.g., registers, through axis reordering and tiling to fully reuse each table as well as reduce the temporary results which compete with the on-chip memory. Operator fusion may be used to improve table precomputation. A bit-serial-like circuit may accommodate various combinations of mixed precision operations. Table quantization and mirror consolidation may be used to reduce the size of tables. The LUT-based kernels described herein thus scale linearly to the weight bitwidth and are unified with regard to weight quantization levels. This allows for the deployment of LLMs on edge devices using widely available CPUs and without relying on GPUs and without compromising computational efficiency. The tiling of the LUT unit can significantly impact performance, as a suboptimal tiling shape increases storage costs and reduces opportunities for table reuse. The CPU may be designed with an elongated tiling shape design to enhance table reuse, and to align with the typical memory hierarchy in an accelerator, enhancing overall efficiency. Tile-based deep learning compilers may leverage the shape information provided in instructions to recompile LLM workloads. This low-overhead recompilation may ensure an efficient and smooth integration of the hardware into the existing LLM ecosystem.

Current implementations for mixed-precision GEMM vary case by case. Each bit-width combination of activation and weight, such as W4A16 and W2A8, requires a specific weight layout and computing kernel. For example, the layout for W3 could pack 2 bits and the other 1 bit in separate, and may leverage different interleaving or swizzling methods for memory alignment or fast decoding. The corresponding computing kernel then needs to unpack this specific layout to a hardware-supported data type for execution.

To provide a unified and scalable solution for mixed-precision GEMM, the present disclosure transforms the dominant data-type-centric computation to bit-wise computation, based on the linear equivalent transformation in Eq. 1. For mixed-precision GEMM, A and W are the activation and weight matrices, respectively. n is the bit-width of the weight. Wᵢ is each bit matrix of W.

$$A \times W = A \times ( {\sum }_{i = 0}^{n - 1} {2}^{i} {W}_{i} ) = {\sum }_{i = 0}^{n - 1} {2}^{i} A \times {W}_{i} \qquad Eq . 1$$

In this way, the diverse weight layouts are reduced to a unified one-bit matrix layout. The diverse computing kernels are reduced to unified multiplication of the activation matrix and the one-bit matrix. Further, bit-wise computation enables the linear scale-down of computation cost with the bit-width reduction.

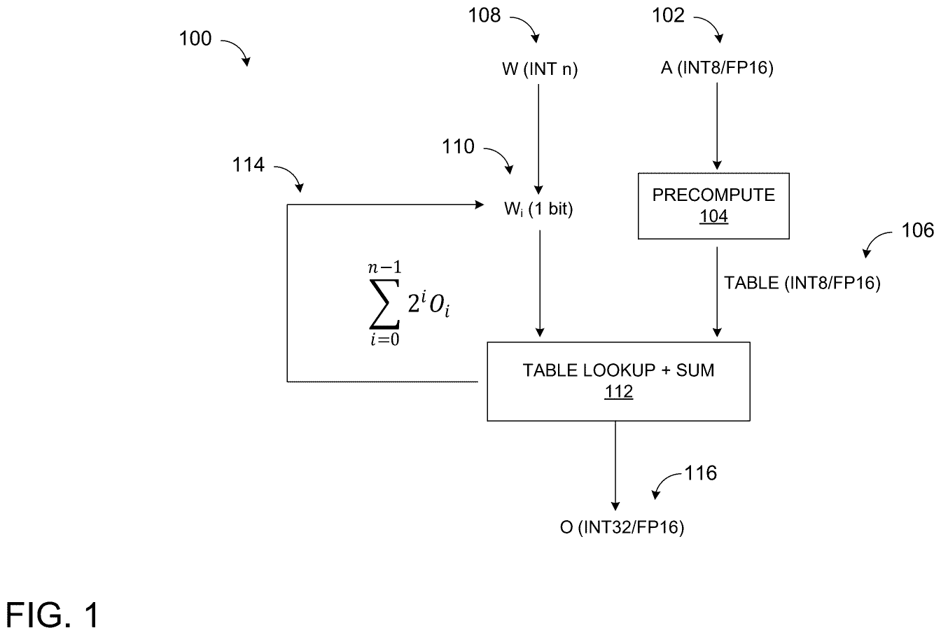

FIG. 1 shows a schematic 100 for bit-wise mpGEMM with LUT implementation, providing unified and scalable solution for any mixed bit-width of activation and weight. At 102, an activation matrix A is received. In this example, the activation matrix is in INT8 or FP16 format. At 104, partial matrix multiplication results for A and a series of one-bit matrices are precomputed. At 106, the partial matrix multiplication results are stored in a lookup table e.g., in INT8/FP16 format. At 108, a weight matrix W is received having a bit-width of n. At 110, weight matrix W is decomposed into Wi (1 bit) matrices. At 112 partial matrix multiplication results are retrieved from the lookup table. This process is iterated at 114 for each 1-bit matrix of the weight matrix decomposition. At 116, the partial results are aggregated into a final mpGEMM result, in this example, in INT32 or FP16 format.

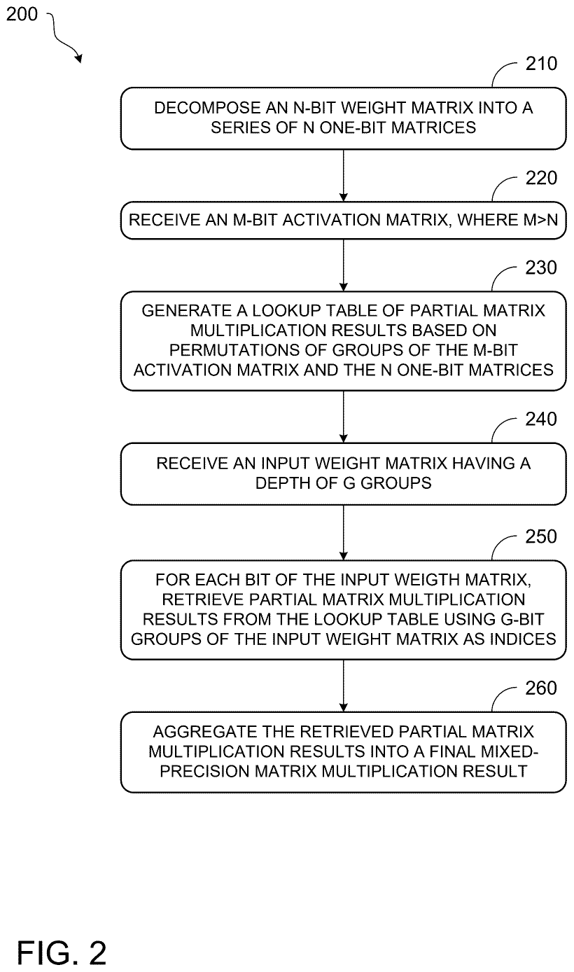

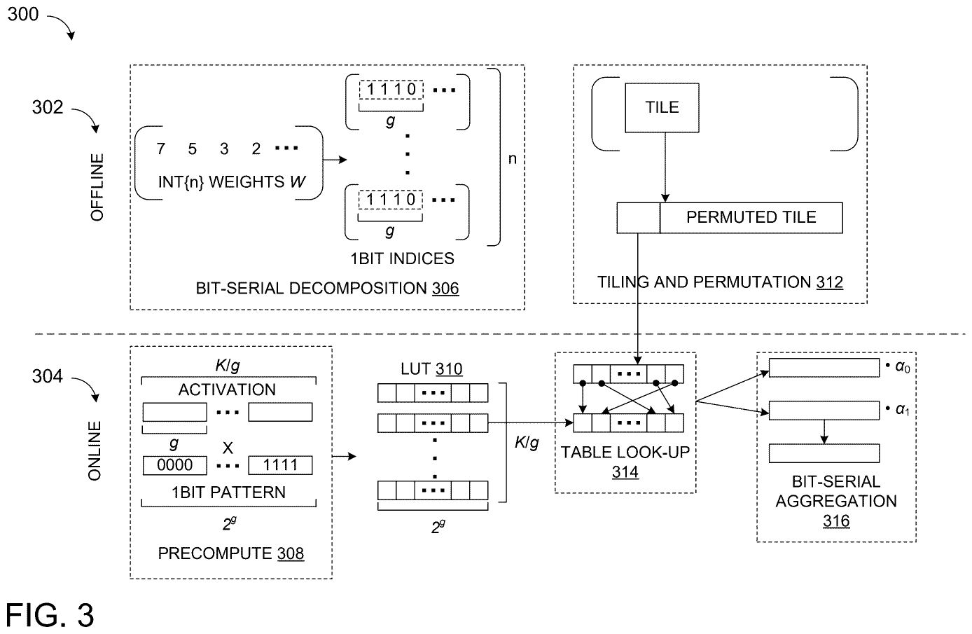

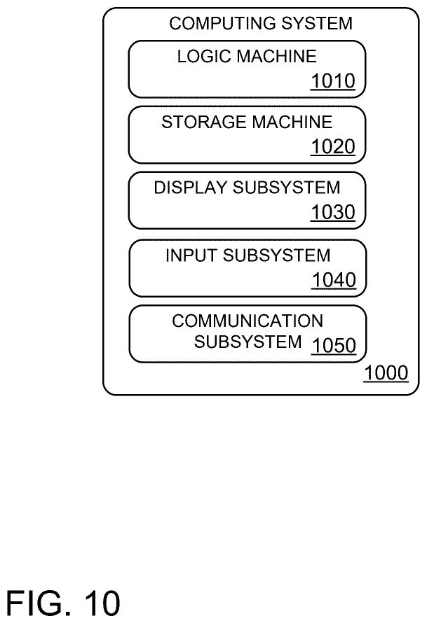

FIG. 2 shows a flow-diagram for an example computer-implemented method 200 for lookup table based mixed-precision matrix multiplication according to one example implementation of the present disclosure. Method 200 may be implemented by hardware and software of a computing system, such as the computing system described herein and with regard to FIG. 10. FIG. 2 will be described with regard to FIG. 3. FIG. 3 shows a schematic 300 for implementing method 200 on a computing device. Schematic 300 shows operations that may be performed offline (302) and online (304). Further, one example implementation of method 200 is shown in Algorithm 1.

Algorithm 1:

LUT-based mpGEMM
input: Activation A of shape N, K,
Weights Wof shape M, K
output: Result matrix R of shape N, M
1 let b be the number of bits in weights
2 W₁, ... ,W_{b} ← PreprocessWeights(W, M, K)
3 LUT ← Precompute(A, N, K)
4 let αᵢ (i ← 1 to b) be the multiplier of bit serial
5 let β be the bias of bit-serial
6 for i ← 1 to b do
7 for n,m ← 1 to N, M do
$8 {R}_{i} [ n , m ] = {\sum }_{k ← 1}^{K} Look - up ( LUT , {W}_{i} , n , m , k )$
Look-up(LUT ,Wi, n,m, k)
9
10 let B be a matrix of shape M, K with all elements β
11 R_{β} ← A • B^{T}
$12 R ← {\sum }_{i ← 1}^{b} {α}_{i} {R}_{i} + {R}_{β}$
13
14 Function Precompute(A, N, K):
15 let g be the group size of LUT table
16 for n, k ← 1 to N, K do
17 for i, j ← 1 to 2^{g}, g do
18 if i & (1 « j ) then
19 LUT[n, k/g, i] += A[n, k]
20 else
21 LUT[n, k/g, i] -= A[n, k]
22 return LUT
23
24 Function PreprocessWeights(W, M, K):
25 for i ← 0 to b do
26 for m, k ← 1 to M, K do
27 Wᵢ[m, k/g] += (W[m, k] » i) « (k % g)
28 returnW₁, ... ,W_{b}

At 210, method 200 includes decomposing an n-bit weight matrix into a series of n one-bit matrices. During the offline preparation stage (302, lines 24 to 28 of Algorithm 1), an n-bit weight matrix is decomposed into n one-bit matrices. Since one bit can only represent two values, for a group with g bits, the possible permutations are only 2^{g}. As shown at 306, a Weight matrix W having a bit width of n and a bit depth of g is decomposed into n one-bit matrices of depth g.

At 220, method 200 includes receiving an m-bit activation matrix, where m>n. As shown at 308 of FIG. 3, the activation matrix may have a length K. The activation matrix may be divided into g groups with a length of K/g.

At 230, method 200 includes generating a lookup table of partial matrix multiplication results based on permutations of groups of the m-bit activation matrix and the n one-bit matrices. Methods for LUT-based mpGEMM include precomputing the dot production of high-precision activation and a set of low-precision weights as a table for the later lookup operations.

As shown at 308 of FIG. 3, given the input activation of a GEMM, every [1, g] vector of the activation may be traversed to multiply with the [g, 2^{g}] bit-pattern matrix and build up a table (e.g., lines 16 to 27 of Algorithm 1). The permutations can be precomputed with each g-width vector of the activation and saved in a table, such as LUT 310.

During the offline stage, a tile in the one-bit matrix can be saved continuously in memory to facilitate fast loading, as shown at 312. Similar to the tiling of normal matrix multiplication, a tiling here also functions to improve data locality and cache utilization during LUT.

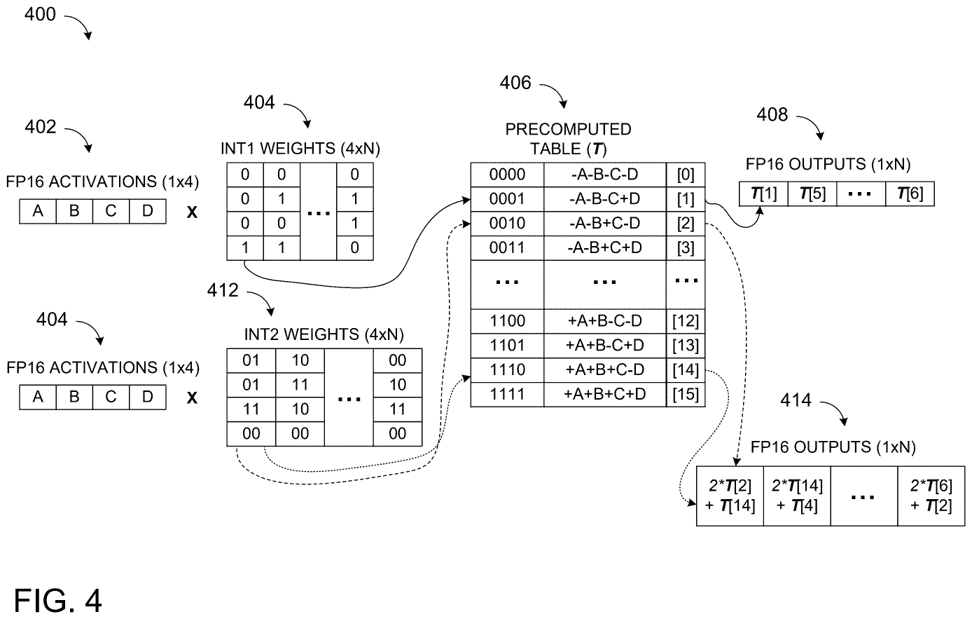

A g-bit group in the weight thus acts an index to look up the table for the precomputed results. This is described further herein and with regard to FIG. 4. Therefore, a table for LUT-based mpGEMM is defined to save the results of a [1, g]×[g, 2^{g}] sub-matrix multiplication, and the table size is [1, 2^{g}].

A hardware implementation of LUT-based mpGEMM involves positioning the precompute unit adjacent to the LUT unit and performing the table precompute for each LUT unit on-the-fly. However, this implementation may significantly introduce hardware cost. Fortunately, the table precompute described herein is an element-wise operation where each element is the production of an activation value and a combination {0, 1} of K that can be processed by a general-purpose compute unit. The precompute table can also be shared by LUT units instead of precomputing a table for each LUT unit to reduce the redundant precomputation. Therefore, a one-time precompute kernel can be enabled for the input activation tensor and the precompute table written to memory. The LUT units can then load the precompute table to the register and perform table lookups.

Additionally, the preceding operator of a mpGEMM is a normalization that is also an element-wise operator. As discussed further, herein, the table precompute operation can be fused into the preceding operators for further optimizations. This helps to mitigate the table precompute overhead to almost zero as evaluated.

At 240, method 200 includes receiving an input weight matrix having a depth of g bits. At 250, method 299 includes, for each bit of the input weight matrix, retrieving partial matrix multiplication results from the lookup table using g-bit groups of the input weight matrix as indices.

As shown at 314, each group of the input weight matrix may be used as an index to lookup a partial matrix multiplication result. During LUT, each index (e.g., group) of the one-bit weight matrix is used to look up the tables for partial results (e.g., lines 6-9 of Algorithm 1).

At 260, method 200 includes aggregating the retrieved partial matrix multiplication results into a final mixed-precision matrix multiplication result. As shown at 316, this may be a bit-serial aggregation. The aggregation of the partial results will be the final mpGEMM results (e.g., lines 12-14 of Algorithm 1).

FIG. 4 illustrates a naïve example 400 of using LUT for FP16 activations multiplied by INT1 or INT2 weights. As shown at 402 and 404, the FP16 activations have a vector length of 4, dividing the activation into 4 groups (A, B, C, D). A precomputed table 406 may be generated for the FP16 activation, resulting in a lookup table of size 16 (e.g., 2⁴). FIG. 4 shows the precomputed table 406 with 16 entries for K=4, W BIT=1. The precomputed table 406 comprises all binary combinations of (A, B, C, D) from 0000 (T[0]) to 1111 (T[15]) In this example, this allows a table lookup to replace a dot product of 4-element vectors. For longer activations or higher-bit weights, a larger lookup table would be required. The precomputed table 406 may be dynamically computed on the fly, so that for every group of four activations, the table can be reused multiple times. Maintaining the activation matrix as a set of four groups allows the table to have merely 16 entries, and it can thus be stored in a CPU register.

A first weight matrix 408 with a bit depth of INT1 is received and reorganized to have N groups of 4 1-bit elements. Each group of four elements (e.g., each column of weight matrix 404) may be used as an index for precomputed table 406. In this example, first group [0, 0, 0, 1] correlates with entry T[1], or [−A, −B, −C, +D]. This partial matrix multiplication result may then be saved. This may be repeated for each g-bit group of weight matrix 404—e.g., column 2 [0, 1, 0, 1] serves as an index for entry T[5] or [−A, +B, −C, +D], column N [0, 1, 1, 0] serves as an index for entry T[6] or [−A, +B, +C, −D]. The set of partial matrix multiplications may then be aggregated to generate the final mpGEMM result, e.g., output 408. In this example, output 410 is a (1×N) matrix with FP16 formatting.

A second weight matrix 412 with a bit depth of INT2 is received and reorganized to have N groups of 4 2-bit elements. Each group of four elements (e.g., each column of weight matrix 412) may be used in a bit wise fashion as an index for precomputed table 406. In this example, the first bit of the first group [0, 0, 1, 0] correlates with entry T[2], or [−A, −B, +C, −D], and the second bit of the first group [1, 1, 1, 0] correlates with entry T[14], or [+A, +B, +C, −D]. These partial matrix multiplication results may then be saved individually or aggregated to for the first entry of output 414 (e.g., 2*T[2]+T[14]).

This may be repeated for each g-bit group of weight matrix 412—e.g., first bit of column 2 [1, 1, 1, 0] serves as an index for entry T[14] or [+A, +B, +C, −D], second bit of column 2 [0, 1, 0, 0] serves as an index for entry T[4] or [−A, +B, −C, −D], etc. The set of partial matrix multiplications may then be aggregated to generate the final mpGEMM result, e.g., output 414. In this example, output 414 is a (1×N) matrix with FP16 formatting. One skilled in the art would recognize that this process can be extended to weights of bit depth INT3 or INT4.

LUT-based mpGEMM needs additional table precomputing process and storage to store the precomputed results. Naïvely, the precomputed dot products of a length K activation vector on the W BIT weight require (2 W BIT) K entries for the table. For each activation element, multiplying it with the W BIT weight has 2 W BIT possible results, constructing the precompute table for this activation element. Therefore, the precomputed table has (2 W BIT) K entries for a length K activation vector.

Bit-serial provides an improvement in representing a W BIT integer as W 1-bit integers, performing multiplication over 1-bit integers with bit shift. This approach can be used to reuse the precomputed table on 1-bit, reducing the table size to 2^{K}. The hardware overheads of such a table can be addressed through operator fusion, which may improve table precompute time, weight reinterpretation and table quantization to reduce the table size.

To effectively integrate LUT-based mpGEMM into existing GPU architectures and ecosystems, a new set of instructions may be implemented in conjunction with a compilation stack based on state-of-the-art deep neural network (DNN) compilers. Such a compilation stack may be enhanced with specialized intrinsics and optimizations, specifically designed to leverage the unique capabilities of LUT-based mpGEMM.

To enable programming for LUT-based mpGEMM, a set of LUTbased Matrix Multiply Assist (MMA) (LMMA) instructions may be defined as an extension of the MMA instruction set in the GPU, e.g., Imma. {M} {N} {K}. {Adtype} {Wdtype} {Accumdtype} {Odtype}. This formula shows the format of LMMA instructions, which is similar to MMA while having different shapes and data types. Specifically, the M, N, and K indicate the shape of the LUT. Adtype, Wdtype, Accumdtype and Odtype indicate the data type of the inputs, accumulation and the output, respectively. Similar to MMA instructions, each LMMA instruction is scheduled to a warp of threads for execution. This warp of threads can calculate the formula Odtype[M, N]=Adtype[M, K]×Wdtype[N, K]+Accumdtype[M, N].

Given the model represented in dataflow graph (DFG), the mix-precision GEMM operator may be transformed to a precompute operator and the LUT-based mpGEMM operator. This transformation may be implemented as a graph optimization pass in a deep learning compiler, such as Welder. The precompute and the LUT-based mpGEMM operator may be registered and the required tile-based representation represented in Welder, enabling the reuse of Welder to perform operator fusion. The element-wise precompute operator may be fused with the element-wide Norm operator prior to the GEMM operator in LMMA, further reducing the table precompute overhead.

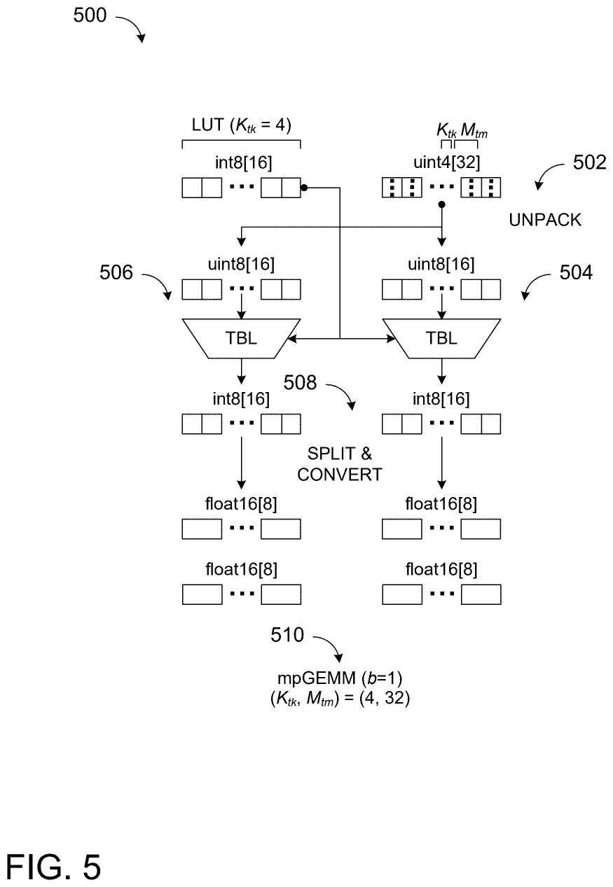

FIG. 5 shows an example data flow 500 for a LUT-based mpGEMM as materialized on a CPU. In this example, the group size is g=4, the tile size of the index matrix is Wᵢ [Kₜₖ, Mₜₘ]=[4, 32], and the bit width is b=4. As shown at 502, the 32 uint4 indices are first unpacked into uint8 bytes to ensure compatibility with the hardware data type and instructions. Subsequently, as shown at 504 and 506, the uint8 indices are utilized to look up the table.

As shown at 508, the results from the look-up are then split and converted to a higher precision for multiplying with the quantization scales of the low-bit LLM model. This is in contrast to general practice models which design specific computing kernels for a 4-bit model, directly decoding the 4-bit weight to int8 to align with hardware data type, and then conducting int8 dot-product for the activation and weight vectors. As shown at 510, the result will be converted into FP16 for multiplying with quantization scales. The cache tiling may be set to W [Kₜₖ, Mₜₘ]=[32, 1], as will be described further herein.

LUT-based mpGEMM introduces some additional challenges in implementation. As compared to the continuous data access of typical practices, the tables are randomly accessed given the indices. The tables may thus be hosted in the fast on-chip memory to reduce the access cost. However, LUT also requires more on-chip memory as compared to typical practices. The table size grows exponentially with the group size g. For instance, when g=4, the LUT is four times larger than the original activation. Additionally, in contrast to the traditional GEMM implementation that yields scalar outputs for each basic block, LUT method results in vector outputs (as shown in FIG. 5), which requires more on-chip memory to store the temporary results. Considering the example in FIG. 3 again, the LUT method uses 144 8-bit registers while llama.cpp uses 104 8-bit registers. To address the above issues a LUT-centric data layout may be implemented to accommodate intermediates and LUT into memory with higher bandwidth. Additionally or alternatively, the size of the LUT may be reduced in order to decrease on-chip storage and limit the number of look-up operations.

As described, the LUT-based method for low-bit GEMM requires additional memory to store both the lookup table and the intermediate results. LUT-based mpGEMM involves fetching partial results from the pre-computed table, which should access the LUT randomly. This leads to memory access inefficiency. To accelerate these table look-ups, the LUT may be placed on registers, leveraging hardware specific instructions (e.g., TBL on advanced RISC machine (ARM) CPUs and PSHUF on x86 CPUs) to do table look-ups and accelerate table accesses. As described further herein, the LUT axis ordering and data tiling may be designed to enhance data reuses, thereby reducing memory consumption. To further improve efficiency, the data layout may incorporate weight permutation to align with memory transactions, and weight interleaving for optimizing weight unpacking.

Additional data layout optimizations may include weight permutation and weight interleaving. Weight permutation may allow for sequential memory access. DRAM involves sequential accesses to achieve higher bandwidth utilization, while accessing tiles in the tiling-based GEMM introduces random accesses because tiles of the input matrices are not sequentially stored. To solve this problem, a weight permutation method may be implemented that permutes the weight matrix to align the weight load with the memory transaction. After the scheduling of a GEMM is determined, the input matrices may be permuted to let tiles stored sequentially instead of the whole matrices (e.g., as shown at 312 of FIG. 3). Specifically, the elements in a tile may be flattened sequentially and then the flattened tiles concatenated according to the tile accessing order. Note that the weight matrix will not be modified during LLM inference, so this permutation can be done in offline. This offline permutation does not introduce cost in inference.

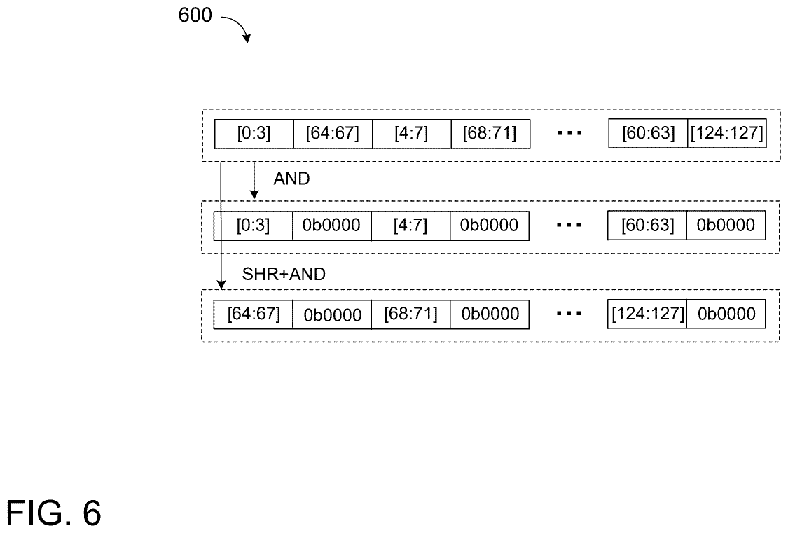

Weight interleaving may allow for fast unpacking of weights. The weight matrix is stored in packed format in memory and are unpacked during computation. However, due to the commonly-used little-endian in modern CPUs, bytes in an integer are stored in a backward order. Therefore, using the integer instructions to unpack the weights involves additional reordering to return the correct unpacked weights. As the weight matrix will not be modified during LLM inference, the packed weights can be interleaved to eliminate this reordering. FIG. 6 schematically shows an example 600 of weight interleaving such that unpacking the interleaved weights can directly produce the unpacked weights sequentially.

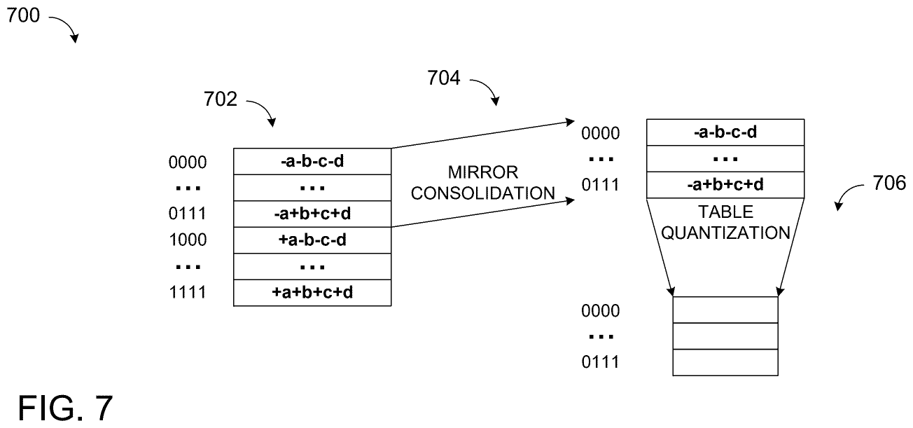

In the realm of LUT-based method for low-bit LLM inference, the size of the lookup table is a factor that impacts both the storage requirements and the access latency, especially when optimizing table look-ups with on-chip memory. A larger table size not only demands more memory space, but also leads to slower table access speed. To address this challenge, FIG. 7 shows two example strategies 700 for reducing the footprint of a LUT 702: mirror consolidation 704 and table quantization 706. Mirror consolidation exploits the symmetrical properties of table values to halve the length of the table, while table quantization applies quantization techniques to the table values themselves to reduce the width of the table. Alone or combined, these methods enable a significant reduction in the storage footprint of the lookup table (up to a quarter of its original size) without accuracy loss in the LLM inference.

The inherent symmetrical properties of table values in the context of lookup tables for LLM inference allow for reducing the LUT footprint. Each positive value within the table is naturally paired with its negative counterpart, reflecting a mirror image across the zero value. Leveraging this symmetry, mirror consolidation capitalizes on the fact that only half of the table values need to be explicitly stored. The remaining half can be rapidly reconstructed by simply negating the stored values. This table compression method is lossless, preserving the model's inference accuracy entirely. Furthermore, it proves to be highly efficient, accelerating the precomputation of the lookup table, reducing the required storage, and speeding up table accesses.

The 2^{K} table length of precomputing a length K activation vector can be represented as a LUT that is symmetric around zero with a math-equivalent linear transformation. It may be assumed that K weights [W_{K-1}, . . . , W₂, W₁, W₀] are represented as a K-bit integer:

$$r = s ( q - z ) \qquad Eq . 3$$

where r is the real value, s is the scale factor, z is the bias, and q is the integer representation to K bits.

To transform such representation to be symmetric around zero, q may mapped to make it symmetric to zero and s and z adjusted correspondingly:

$${q}^{′} = 2 q - ( {2}^{K} - 1 ) , {s}^{′} = s / 2 , {z}^{′} = 2 z + 1 - {2}^{K} \qquad Eq . 4$$

By calculating the values of s′ and z′, q′ is mapped from {0, 1, . . . , 14, 15} to {−15, −13, . . . , 13, 15}, which is symmetric around zero.

A dot product may be considered between the binary representation W₃W₂W₁W₀=0100 and variables A, B, C, D. Initially, the binary values {‘0’, ‘1’} are interpreted as {0, 1}. The calculation proceeds as follows:

$$r = s \cdot ( q - z ) = 1 \cdot ( B - 0 ) = B \qquad Eq . 5$$

After reinterpretation, the binary values {‘0’, ‘1’} are redefined to mean {−1, 1}, with the scale factor s′ adjusted to 0.5 and the bias z′ recalculated as −(A+B+C+D). The updated computation is:

$$r = {s}^{′} \cdot ( {q}^{′} - {z}^{′} ) = 0.5 \cdot ( ( - A + B - C - D ) + ( A + B + C + D ) ) = B \qquad Eq . 6$$

Equations 5 and 6 thus remain mathematically equivalent.

As the table entries are symmetric about zero, the lookup table exhibits properties similar to odd functions. Assuming the index is a 4-bit value W₃W₂W₁W₀, a naïve implementation of the lookup table (LUT) requires 2⁴=16 entries. However, it can be observed that the following property, akin to that of odd functions, holds:

$$LUT [ {W}_{3} {W}_{2} {W}_{1} {W}_{0} ] = - LUT [ ∼ ( {W}_{3} {W}_{2} {W}_{1} {W}_{0} ) ] \qquad Eq . 7$$

Therefore, the number of entries in the LUT can be reduced to half of the original, which is 2⁴⁻¹=8, and the equation becomes:

$$LUT [ {W}_{3} {W}_{2} {W}_{1} {W}_{0} ] = \{ \begin{matrix}- LUT [ ∼ ( {W}_{2} {W}_{1} {W}_{0} ) ] , & if {W}_{3} = 1 \\ LUT [ {W}_{2} {W}_{1} {W}_{0} ] , & if {W}_{3} = 0\end{matrix} \qquad Eq . 8$$

Therefore, given a length K activation vector, table symmetrization can reduce the table length to 2^{K-1}. The table size not only affects the computational operations required during the precompute stage, but also the size of the multiplexing units (MUX). Furthermore, each entry in the table also is broadcast to N PEs, typically 64 or 128, for dot product computations. Such an optimization significantly reduces the broadcasting overhead and the MUX selection overhead, thereby enhancing the energy efficiency and area efficiency of the circuit.

Note that W₃W₂W₁W₀ in Equation 8 are all weights, which will not be modified in inference. As such, the bit-level negation can be done by offline weight transformation and the equation can further be simplified to:

$$LUT [ {W}_{3}^{′} {W}_{2}^{′} {W}_{1}^{′} {W}_{0}^{′} ] = \{ \begin{matrix}- LUT [ ( {W}_{2}^{′} {W}_{1}^{′} {W}_{0}^{′} ) ] , & if {W}_{3}^{′} = 1 \\ LUT [ {W}_{2}^{′} {W}_{1}^{′} {W}_{0}^{′} ] , & if {W}_{3}^{′} = 0\end{matrix} \qquad Eq . 9$$

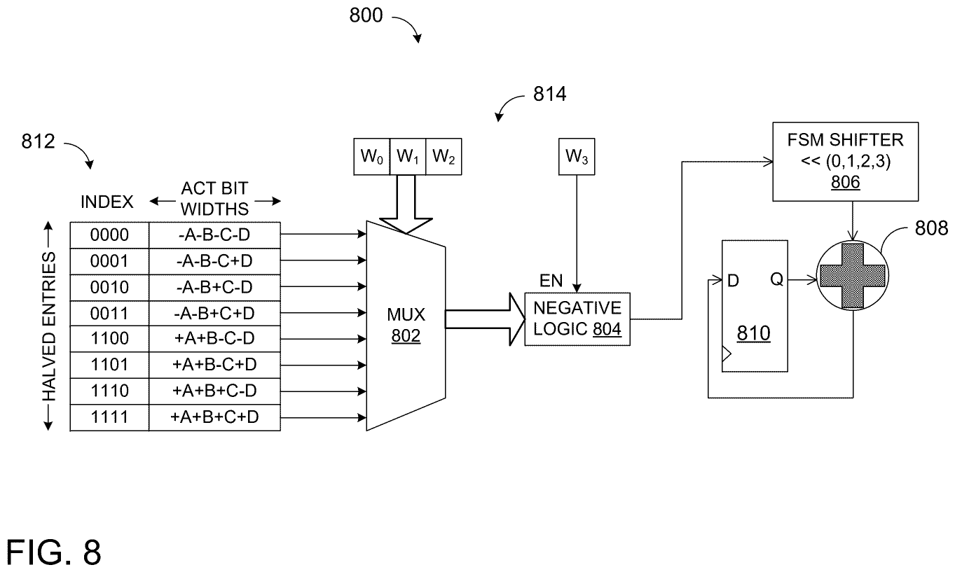

This simplification can eliminate the negation operation in circuit design, as described herein with regard to FIG. 8.

Table symmetrization can reduce the table size by half. Moreover, for high precision activations, such as FP32 or FP16, table quantization techniques may be utilized to quantize the precomputed table elements to a lower, unified precision, such as INT8. This approach offers flexibility by supporting multiple activation precisions and efficiency by reducing storage requirements through lower precision table elements.

Table quantization operates on a principle analogous to weight and activation quantization, aiming to reduce the precision of table values for improved computational efficiency. For instance, values initially represented in 16-bit floating-point (FP16) within a lookup table can be quantized to 8-bit integer (INT8) with a scaling factor.

The impact of table quantization on model accuracy is negligible. Contrary to activation quantization, which has been challenging in maintaining model accuracy due to its necessity for coarse granularity and static quantization to ensure fast computation, table quantization may be implemented with finer granularity during the precomputation phase and dynamic quantization to minimize accuracy degradation. For instance, with a group size of 4 activation elements, quantization may be performed for each generated table with 8 precomputed dot-products.

In terms of efficiency, table quantization significantly reduces lookup table storage requirements and accelerates the lookup process, while maintaining higher accuracy compared to conventional activation quantization.

By leveraging software-based precompute fusion and weight reinterpretation, the hardware cost for customizing each individual LUT unit is significantly reduced. Each LUT unit is simple and easy to scale out. FIG. 8 schematically shows an example LUT unit 800 with bit-serial circuit architecture. LUT unit 800 comprises multiplexer (MUX) 802, negative logic 804, finite state machine (FSM) shifter 806, XOR 808, and D flip flop 810. Upon receipt of weights 812, MUX 802 can retrieve partial matrix multiplication results from lookup table 814 stored in a register of a central processing unit.

In comparison to a naïve design, the registers needed to store LUT 814 can be halved, and the cost of the table broadcasting and MUX is also halved. Moreover, as depicted in equation 9, at least a portion of the typical bit-level negation circuit can be eliminated from each LUT unit 800, resulting in lower area and power consumption in the hardware. To support flexible bit-widths for weights, a bit-serial circuit architecture is employed. This design unfolds the weight bit-width to W BIT cycles, thereby enabling the processing of different bit-widths in a serialized manner. This bit-serial approach allows the hardware to adapt to various precision levels without the need for multiple distinct hardware implementations.

Similar to GEMM, scheduling a LUT-based mpGEMM operator involves careful consideration of tiling on the memory hierarchy for performance. GPUs have a memory hierarchy of global memory, shared memory, registers, and tiling on the memory hierarchy that can significantly improve the data reuse on on-chip memory to improve performance.

Conventional tiling strategies for GEMM assume the same data type on both activation and weight and focus on adjusting the tiling shape on memory hierarchy. However, mpGEMM has different data types on activation and weight, resulting in different memory behaviors for tensors of different data types. Tiling may thus be represented with the actual memory size instead of tiling shape. The shape of LMMA instructions may be registered, and this tiling and stored in tile interfaces to schedule the proper tiling configurations. With the finalized scheduling plans, code generation may be performed using a compiler such as a tensor virtual machine (TVM), following the scheduling to generate the kernel code with LMMA instructions.

To fully explore the potential of onchip memory table look-ups, lookup table axes may be reordered and elongated tiling implemented to enhance data reuses to reduce the on-chip memory pressure.

For GEMM where C[N, M]=A[N, K]×W[M, K], it is natural to loop among the spatial axes N and M, and then the temporal axis K. However, the LUT-based GEMM may build the table along the K axis, resulting in extreme large table storage when first looping the spatial axes followed by the temporal axis following the traditional GEMM, e.g., a lookup table for the whole A[N, K]. However, if the axis order is swapped from spatial first to temporal second, it will maintain a small lookup table [1, K]. As such, the axes access may be reordered to temporal axis K first and then spatial axes N and M.

Tiling is a common technique in optimizing data locality of GEMM and reducing the memory requirements by reusing data on on-chip memory. Assume the GEMM C[N, M]=A[N, K]×W[M, K] is processed with tile A[Nₜₙ, Kₜₖ] and W[Mₜₘ, Kₜₖ], processing a tile requires Nₜₙ*Kₜₖ+Mₜₘ*Kₜₖ data loading from DRAM to processor's on-chip memory instead of Nₜₙ*Mₜₘ*Kₜₖ data loading. In traditional GEMM, the tile size Nₜₙ and Mₜₘ have equal effects on efficiency while Kₜₖ does not affect the data reusing and is set to align the memory transaction. However, in LUT-based GEMM, the activation A[N, K] can be processed to build the lookup table, while the weight W[M, K] can share the same pre-computed lookup table. That is to say, a larger tile size Mₜₘ on M can lead to improved lookup table reusing. As such, an elongated tiling shape may be used. Accordingly, careful consideration of the tiling configurations Nₜₙ, Mₜₘ, and Kik may improve performance of LUT-based mpGEMM, as traditional choices for MAC-based Tensor Cores may potentially lead to suboptimal performance in this context.

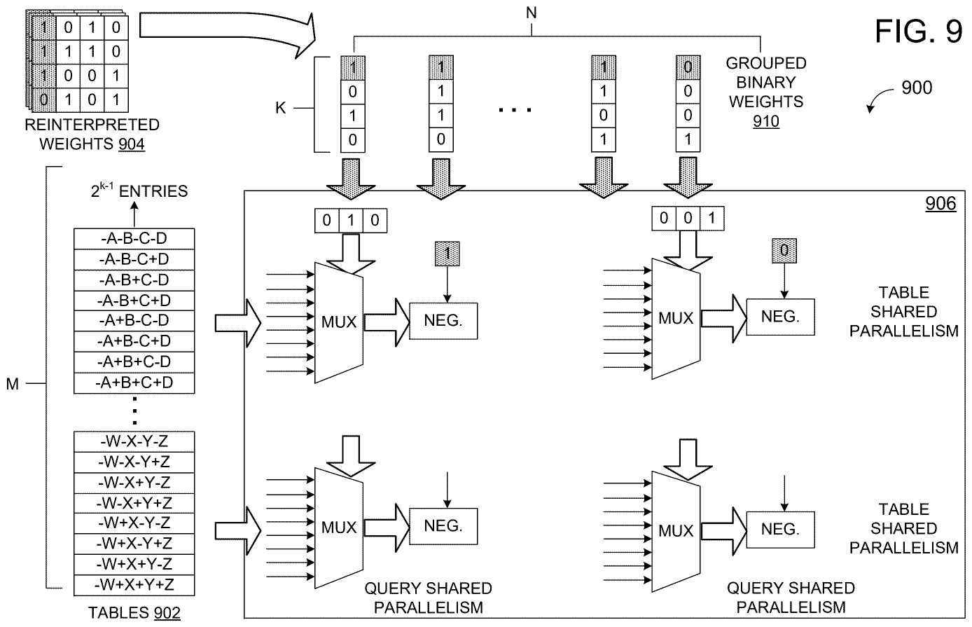

As illustrated in FIG. 9, a MNK Tile's LUT Array 900 comprises M tables 902, N sets of reinterpreted weights 904, and (M*N) MUX-based units 906. Each table 902 contains M×2^{K-1} entries, with each table entry broadcast to N of MUX units 906. Each set of grouped binary weights 910 includes K bits, which are each broadcast to M MUX units to act as select signals for the MUX. The total table size is given by the equation:

$$Total Table Size = M \times {2}^{K} - 1 \times LUT BIT \qquad Eq . 10$$

and the size for grouped binary weights is given by:

$$Grouped Binary Weights Size = K \times N \times W BIT \qquad Eq . 11$$

where LUT BIT is the bit width of the LUT entries, and W BIT is the bit width of the weights.

With a large K, the size of table entries explodes exponentially, whereas N represents the potential reuse of each table entry across multiple MUX units. As such, a balance may be struck with a suitably sized K, a larger N, and a smaller M—a configuration that diverges from the typical demands of conventional GPU Tensor Cores. This shape also impacts tiling, as a more square-like tiling configuration can lead to lower I/O traffic. Therefore, a balance may also be struck between the size of the LUT and weight within a tile as closely as possible.

Experimental data verifies that elongated tiling shapes achieve increased efficiency. In one example (data not shown) computational capabilities were aligned with those of the A100 INT8 Tensor Core, which delivers 1024 operations per cycle per Tensor Core, setting M×N×K=512 for extensive design space exploration. Input data types ranged from AFP16 to AINT8 and include various weight bit-widths. The disclosed LUT-based mpGEMM approach was compared to MAC and ADDINT1 based approaches. To make a fair comparison across difference activation data types, table quantization was not enabled for this benchmark.

In hardware experiments, M and N to 1 were fixed to 1 and K varied (e.g., a dot product unit of K-element vectors) to explore its impact on compute density. Excessively large K could potentially lead to an exponential growth in lookup table entries, thereby increasing area without proportional gains in efficiency. Conversely, smaller K may lead to an inefficient dominance of computations being handled by adders, which could reduce compute density. In hardware experiments, INT operations achieve optimal density at K=4, while floating-point operations peaked at K=5 but perform similarly well at K=4. As such, K=4 was used for all subsequent LUT-based experimental designs.

Following K=4, benchmarks were conducted on dot product implementations using MAC-based, ADD-based, and LUT-based approach across various data formats. The configurations assessed include conventional symmetric precision with MAC (WFP16AFP16, WFP8AFP8) and mixed precision (WINT1AFP16, WINT1AFP8) using both ADD and LUT approaches. The LUT-based approach achieved the highest compute density, reaching 61.55 TFLOPs/mm2 with WINT1AFP16, substantially surpassing the conventional MAC configuration which registered only 3.39 TFLOPs/mm2 with WFP16AFP16. The behavior of power efficiency exhibited similar performance. Specifically, under the AFP16 format, the LUT-based approach delivered an 18.13× increase in compute density and reduced power consumption by 15.45× compared to MAC methods.

Further, weight-bit scaling experiments were conducted on the WINTX×AFP16 DP4 units for MAC-based, ADD-based, and LUT-based implementations. The experiments were configured with the tensor core's N dimension set to 4 to match the A100's configuration. The conventional LUT-based implementation does not have area advantages compared to the MAC baseline when the weight is more than 2-bit. The main area efficiency bottleneck is the table precompute and storage overheads. ADD-based implementations also only surpass the MAC baseline in the 1-bit and 2-bit cases. By optimizing the table storage overhead and the precompute overhead with symmetry-based table reduction and compilation optimizations, the disclosed LUT-based mpGEMM implementation outperformed all the baselines up to a weight bit-width of 6 and delivers much greater area efficiency compared to the conventional LUT implementation.

Across 12 sets of experiments with different activation data formats and weight bit-widths, the disclosed method achieves the smallest area and lowest power consumption, except in the WINTSAINT4 case. Notably, with 1-bit weights, the disclosed approach exhibits a 4×-6× reduction in power and area compared to the MAC-base Tensor Core design. The design space exploration identified an M2N64K4 configuration as a highly efficient MNK configuration for the LUT-based mpGEMM.

Numerous details may be incorporated in implementing LUT-based mpGEMM into software and hardware. TVM and/or low-level virtual machine (LLVM) may be employed for code generation. This allows for the generation of optimal code for GEMM of varying shapes and for different hardware, and to implement common optimizations such as loop unrolling, vectorization, and constant folding. TVM Tensorize may be used to embed hardware intrinsics into the code. AutoTVM may be used to automatically fine-tune the generated code for different hardware targets.

A consistent API may be provided for both C++ and Python. As an example, the GEMM functions may be encapsulated into TVM PackedFunc, and the tensors can be transferred through the DLPack tensor structure. This facilitates easy interoperability with other frameworks like PyTorch, Numpy, etc. Additionally, an additional wrapper may be provided for C++, where tensors can be passed through raw pointers and TVM runtime dependency is eliminated. This offers a more lightweight solution for integration into other C++ projects.

The TVM runtime threadpool may be utilized to dynamically assign tasks to CPUs. However, when integrating T-MAC into llama.cpp, there may be a conflict between the llama.cpp threadpool and the TVM threadpool. This conflict arises as threads from different threadpools compete for CPU resources, leading to a significant performance degradation. To resolve this issue, C++ code may be generated using TVM, rather than directly creating library files, and then the code postprocessed to remove the dependency on the TVM runtime and threadpool. Such a generated function will only execute computations of a single threadblock, and then these threadblocks may be assigned to different threads in the llama.cpp threadpool. This approach achieves improved performance and compatibility with llama.cpp. The portable C++ code also offers an option for cross-platform deployment.

After loading the table into registers, hardware intrinsics provided by ARM NEON/INTEL advanced vector extension (AVX2) can be utilized. Both NEON/AVX2 offer 8-bit look-up instructions. The bit width of ARM NEON is 128, which can precisely accommodate the entire table of g=4. INTEL AVX2 has a bit width of 256, but the lower and upper halves are in separate 128-bit lanes. Therefore, the table may be duplicated to fill the 256-bit LUT register and look up 32 different int8 weight indices with a single instruction. If the table's data type is float16, since NEON/AVX2 do not support 16-bit LUT, float16 may be split into two 8-bit LUTs, one for the lower part and the other for the higher part. The lower and higher parts may be looked up with two instructions and then recombined into float16.

Besides table look-up, aggregation is another significant computational overhead. To speed up the aggregation, the look-up results may initially be aggregated in low bit the aggregation sum later converted to a higher precision like float16 with no accuracy loss. Moreover, fast 8-bit aggregation can be implemented if the table is quantized to int8. Normally, the int8 values can be converted to int16 to avoid overflow. However, int16 instructions have half the throughput of int8 aggregation. As an alternative, avg/rhadd instructions can be used to compute the average and minimize accuracy loss by subtracting the probabilistic bias from the final value. Notably, fast 8-bit aggregation could result in nonnegligible accuracy loss.

In the described weight matrix decomposition, the original values of vᵢ, e.g., 0 and 1 were utilized. However, a linear transformation can be introduced to these values. This linear transformation may be denoted as f(vᵢ) and the transformed values as f(0)=s₀ and f(1)=s₁. To speed up precomputation and reduce quantization error, the values of s0 and s1 may be chosen with care. To circumvent float-multiply instructions, they may be selected from the set [−1, 0, 1]. To reduce quantization error, it may be beneficial to minimize the difference between the largest and smallest entries of the LUT. From empirical studies, values may be chosen as s₀=−1 and s₁=1. By setting the values of s₀ and s₁, the linear transformation f is defined, and the decomposition of W may be adjusted as follows:

$$f ( {v}_{i} ) = {α}_{i}^{′} {v}_{i} + {β}_{i}^{′} , {v}_{i} = {α}_{i} f ( {v}_{i} ) + {β}_{i} ; \qquad Eq . 12$$

$$where {α}_{i} = \frac{1}{{α}_{i}^{′}} , β = - \frac{{β}_{i}^{′}}{{α}_{i}^{′}}$$

$$W = {\sum }_{i = 0}^{b - 1} {α}_{i} {2}^{i} {W}_{i}^{′} + B ,$$

$$where {W}_{i}^{′} = f ( {W}_{i} ) , B = J \cdot {\sum }_{i = 0}^{b - 1} {β}_{i} {2}^{i}$$

and J is a matrix of ones.

As described, subtraction/addition instructions may be used instead of multiplication instructions to achieve higher throughput. For the LUT of shape (N, K/g, 2^{g}), the subtraction/addition can be vectorized along the K/g axis. For instance,

$$\begin{matrix}LUT [ 0 , 0 : 8 , 0 ] = - A [ 0 , 0 : 32 : 4 ] - A [ 0 , 1 : 32 : 4 ] \\ - A [ 0 , 2 : 32 : 4 ] - A [ 0 , 3 : 32 : 4 ]\end{matrix} \qquad Eq . 13$$

The indexing into A is not contiguous. By employing LD4 in NEON and vgatherdps in AVX2, non-contiguous data can be efficiently loaded. However, when writing the noncontiguous LUT back into memory, extracting specific bytes from a single instruction, multiple data (SIMD) register and writing to memory is highly inefficient for AVX2. To address this issue, register swizzling may be used to rearrange the LUT so that it can be written back to memory contiguously. Initially, vpblendvb may be used to blend 8-bit values from different registers into one register, followed by vpermd to swizzle the 32-bit values of the 256-bit, and then vpshufb to further shuffle the 8-bit values into the correct order. After swizzling, the LUT can be written back to memory in a contiguous manner.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic machine 1010 and a storage machine 1020. Computing system 1000 may optionally include a display subsystem 1030, input subsystem 1040, communication subsystem 1050, and/or other components not shown in FIG. 10. LUT unit 800 and LUT array 900 are examples of computing system 1000.

Logic machine 1010 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1020 includes one or more physical devices configured to hold instructions executable by the logic machine to implement the methods and processes described herein. When such methods and processes are implemented, the state of storage machine 1020 may be transformed—e.g., to hold different data.

Storage machine 1020 may include removable and/or built-in devices. Storage machine 1020 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1020 may include volatile, nonvolatile, dynamic, static, read/write, read-only, random-access, sequential-access, location-addressable, file-addressable, and/or content-addressable devices.

It will be appreciated that storage machine 1020 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1010 and storage machine 1020 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1010 executing instructions held by storage machine 1020. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1030 may be used to present a visual representation of data held by storage machine 1020. This visual representation may take the form of a graphical user interface (GUI). As the herein described methods and processes change the data held by the storage machine, and thus transform the state of the storage machine, the state of display subsystem 1030 may likewise be transformed to visually represent changes in the underlying data. Display subsystem 1030 may include one or more display devices utilizing virtually any type of technology. Such display devices may be combined with logic machine 1010 and/or storage machine 1020 in a shared enclosure, or such display devices may be peripheral display devices.

When included, input subsystem 1040 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1050 may be configured to communicatively couple computing system 1000 with one or more other computing devices. Communication subsystem 1050 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

In one example, a method for mixed-precision matrix multiplication, comprises decomposing an n-bit weight matrix into a series of n one-bit matrices; receiving an m-bit activation matrix, where m>n; generating a lookup table of partial matrix multiplication results based on permutations of groups of the m-bit activation matrix and the n one-bit matrices; receiving an input weight matrix having a depth of g bits; for each bit of the input weight matrix, retrieving partial matrix multiplication results from the lookup table using g-bit groups of the input weight matrix as indices; and aggregating the retrieved partial matrix multiplication results into a final mixed-precision matrix multiplication result. In such an example, or any other example, the lookup table is additionally or alternatively stored in a register of a central processing unit. In any of the preceding examples, or any other example, the lookup table is additionally or alternatively accessed via parallel lookup. In any of the preceding examples, or any other example, a tile in the series of n one-bit matrices is additionally or alternatively saved continuously in memory. In any of the preceding examples, or any other example, input weight matrices are additionally or alternatively permuted so that weight matrix tiles of the input weight matrices are stored sequentially. In any of the preceding examples, or any other example, input weight matrices are additionally or alternatively stored in a packed format, and the stored input weight matrices are additionally or alternatively interleaved. In any of the preceding examples, or any other example, the lookup table is additionally or alternatively compressed using mirror consolidation. In any of the preceding examples, or any other example, the lookup table is additionally or alternatively quantized with a scaling factor. In any of the preceding examples, or any other example, the lookup table is additionally or alternatively accessed first via a temporal axis followed by spatial axes.

In another example, a computing system comprises a central processing unit; and a storage machine holding instructions executable by the central processing unit to decompose an n-bit weight matrix into a series of n one-bit matrices; receive an m-bit activation matrix, where m>n; generate a lookup table of partial matrix multiplication results based on permutations of groups of the m-bit activation matrix and the n one-bit matrices; store the lookup table in a register of the central processing unit; receive an input weight matrix having a depth of g bits; for each bit of the input weight matrix, retrieve partial matrix multiplication results from the lookup table using g-bit groups of the input weight matrix as indices; and aggregate the retrieved partial matrix multiplication results into a final mixed-precision matrix multiplication result. In such an example, or any other example, the lookup table is additionally or alternatively accessed via parallel lookup. In any of the preceding examples, or any other example, a tile in the series of n one-bit matrices is additionally or alternatively saved continuously in memory. In any of the preceding examples, or any other example, input weight matrices are additionally or alternatively permuted so that weight matrix tiles of the input weight matrices are stored sequentially. In any of the preceding examples, or any other example, input weight matrices are additionally or alternatively stored in a packed format, and wherein the stored input weight matrices are interleaved. In any of the preceding examples, or any other example, the lookup table is additionally or alternatively compressed using mirror consolidation. In any of the preceding examples, or any other example, the lookup table is additionally or alternatively quantized with a scaling factor. In any of the preceding examples, or any other example, the lookup table is additionally or alternatively accessed first via a temporal axis followed by spatial axes.

In yet another example, a computing system comprises a central processing unit comprising a register and at least one LUT unit with bit-serial circuit architecture, the LUT unit comprising N×M multiplexing units; and a storage machine holding instructions executable by the central processing unit to: for an activation matrix A[M, K] and a weight matrix W[N, K], decompose the weight matrix into N grouped binary weights of K bits each; tile a look-up table array in the register comprising M tables, each table containing M×2^{K-1} entries, each table comprising permutations of groups of the activation matrix and the grouped binary weights; broadcast the grouped binary weights to M multiplexing units; broadcast each table entry to N multiplexing units; retrieve partial matrix multiplication results from the look-up table array based on each grouped binary weight; and aggregate the retrieved partial matrix multiplication results into a final mixed-precision matrix multiplication result. In such an example, or any other example, the partial matrix multiplication results from the look-up table array are additionally or alternatively retrieved in parallel. In any of the preceding examples, or any other example, the look-up table array is additionally or alternatively tiled along the K axis first, followed by the M and N axes.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for mixed-precision matrix multiplication, comprising:
decomposing an n-bit weight matrix into a series of n one-bit matrices;
receiving an m-bit activation matrix, where m>n;
generating a lookup table of partial matrix multiplication results based on permutations of groups of the m-bit activation matrix and the n one-bit matrices;
receiving an input weight matrix having a depth of g bits;
for each bit of the input weight matrix, retrieving partial matrix multiplication results from the lookup table using g-bit groups of the input weight matrix as indices; and
aggregating the retrieved partial matrix multiplication results into a final mixed-precision matrix multiplication result.

2. The method of claim 1, wherein the lookup table is stored in a register of a central processing unit.

3. The method of claim 2, wherein the lookup table is accessed via parallel lookup.

4. The method of claim 1, wherein a tile in the series of n one-bit matrices is saved continuously in memory.

5. The method of claim 1, wherein input weight matrices are permuted so that weight matrix tiles of the input weight matrices are stored sequentially.

6. The method of claim 1, wherein input weight matrices are stored in a packed format, and wherein the stored input weight matrices are interleaved.

7. The method of claim 1, wherein the lookup table is compressed using mirror consolidation.

8. The method of claim 1, wherein the lookup table is quantized with a scaling factor.

9. The method of claim 1, wherein the lookup table is accessed first via a temporal axis followed by spatial axes.

10. A computing system, comprising:
a central processing unit; and
a storage machine holding instructions executable by the central processing unit to:
decompose an n-bit weight matrix into a series of n one-bit matrices;
receive an m-bit activation matrix, where m>n;
generate a lookup table of partial matrix multiplication results based on permutations of groups of the m-bit activation matrix and the n one-bit matrices;
store the lookup table in a register of the central processing unit;
receive an input weight matrix having a depth of g bits;
for each bit of the input weight matrix, retrieve partial matrix multiplication results from the lookup table using g-bit groups of the input weight matrix as indices; and
aggregate the retrieved partial matrix multiplication results into a final mixed-precision matrix multiplication result.

11. The computing system of claim 10, wherein the lookup table is accessed via parallel lookup.

12. The computing system of claim 10, wherein a tile in the series of n one-bit matrices is saved continuously in memory.

13. The computing system of claim 10, wherein input weight matrices are permuted so that weight matrix tiles of the input weight matrices are stored sequentially.

14. The computing system of claim 10, wherein input weight matrices are stored in a packed format, and wherein the stored input weight matrices are interleaved.

15. The computing system of claim 10, wherein the lookup table is compressed using mirror consolidation.

16. The computing system of claim 10, wherein the lookup table is quantized with a scaling factor.

17. The computing system of claim 10, wherein the lookup table is accessed first via a temporal axis followed by spatial axes.

18. A computing system, comprising:
a central processing unit comprising a register and at least one LUT unit with bit-serial circuit architecture, the LUT unit comprising N×M multiplexing units; and
a storage machine holding instructions executable by the central processing unit to:
for an activation matrix A[M, K] and a weight matrix W[N, K]:
decompose the weight matrix into N grouped binary weights of K bits each;
tile a look-up table array in the register comprising M tables, each table containing M×2^{K-1} entries, each table comprising permutations of groups of the activation matrix and the grouped binary weights;
broadcast the grouped binary weights to M multiplexing units;
broadcast each table entry to N multiplexing units;
retrieve partial matrix multiplication results from the look-up table array based on each grouped binary weight; and
aggregate the retrieved partial matrix multiplication results into a final mixed-precision matrix multiplication result.

19. The computing system of claim 18, wherein the partial matrix multiplication results from the look-up table array are retrieved in parallel.

20. The computing system of claim 18, wherein the look-up table array is tiled along the K axis first, followed by the M and N axes.
